(19) United States
(12) Patent Application Publication
(10) Pub. No.: US 2007/0186191 A1
(43) Pub. Date: Aug. 9, 2007

(54) Method of visualizing a pointer during interaction

(75) Inventors: Bernardus Hendrikus Maria Kraemer, Eindhoven (NL); Najang Klootwijke, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/580,494

(22) PCT Filed: Nov. 23, 2004
(86) PCT No.: PCT/IB04/52509

§ 371 Date: May 23, 2006

(30) Foreign Application Priority Data
Nov. 27, 2003 (EP) 03104410.0

(51) Int. Cl. G09G 5/08

(52) U.S. Cl. 715/856; 715/857; 345/157

(57) ABSTRACT

The invention relates to a method of visualizing a pointer during interaction of the pointer with an image, the pointer being controllable by a user, the method comprising: moving the pointer to a first position within the image by the user, displaying the pointer corresponding to an interaction mode related to the first position within the image; selecting the interaction mode; moving the pointer to a second position within the image by the user while performing the selected interaction mode upon the image; and hiding the pointer during moving the pointer to the second position within the image. The invention further relates to a system (500) for visualizing a pointer during interaction of the pointer with an image, the pointer being controllable by a user, the system comprising: a mover (502) for moving the pointer to a first position within the image by the user, a displayer (504) for displaying the pointer corresponding to an interaction mode related to the first position within the image; a selector (506) for selecting the interaction mode; a mover (502) for moving the pointer to a second position within the image by the user while performing the selected interaction mode upon the image; and a hider (508) for hiding the pointer during moving the pointer to the second position within the image.

The invention relates to a method of visualizing a pointer during interaction of the pointer with an image, the pointer being controllable by a user.

The invention further relates to a system for visualizing a pointer during interaction of the pointer with an image, the pointer being controllable by a user.

The invention further relates to a computer program product to perform such a method.

The invention further relates to a computer readable medium having stored thereon instructions for causing one or more processing units to perform such a method.

The invention further relates to an imaging diagnostic apparatus for carrying out such a method.

Computing devices, such as a personal computer (pc), a workstation, a personal digital assistant (pda), etc are arranged to display images onto a screen that is connected to the computing device. The displayed images can have all kinds of formats like jpeg, TIFF, gif, etc. and the images can have all kinds of sources, like a digital still camera, or a medical image acquisition system, like a computerized tomography scanner (CT-scanner), a magnetic resonance scanner (MR-scanner), an X-ray scanner, etc. Further, the images can also be drawings of objects that can for example be displayed within a text-based document like MsWord of Microsoft Corporation. or a drawing from a drawing application like Autocad of Autodesk For example, within most text-processing applications it is possible for a user to draw objects like arrows, boxes, spheres, etc. A user can instruct the computing device to perform image enhancement operations upon the image like zooming, panning, adjusting contrast/brightness, adjusting the color/position/size/shape of objects like boxes, spheres, poly-lines, etc. The user can control the position within the image where a specific image enhancement operation should be performed, by controlling an input device that is connected to the computing device. Such an input device is for example a mouse or a stylus. The input device is visualized upon the screen by a cursor and the user can control the position of the cursor within the image by manipulating the input device. Usually, the computing device gives feedback to the user of the chosen image enhancement operation by displaying a cursor that corresponds to the chosen operation.

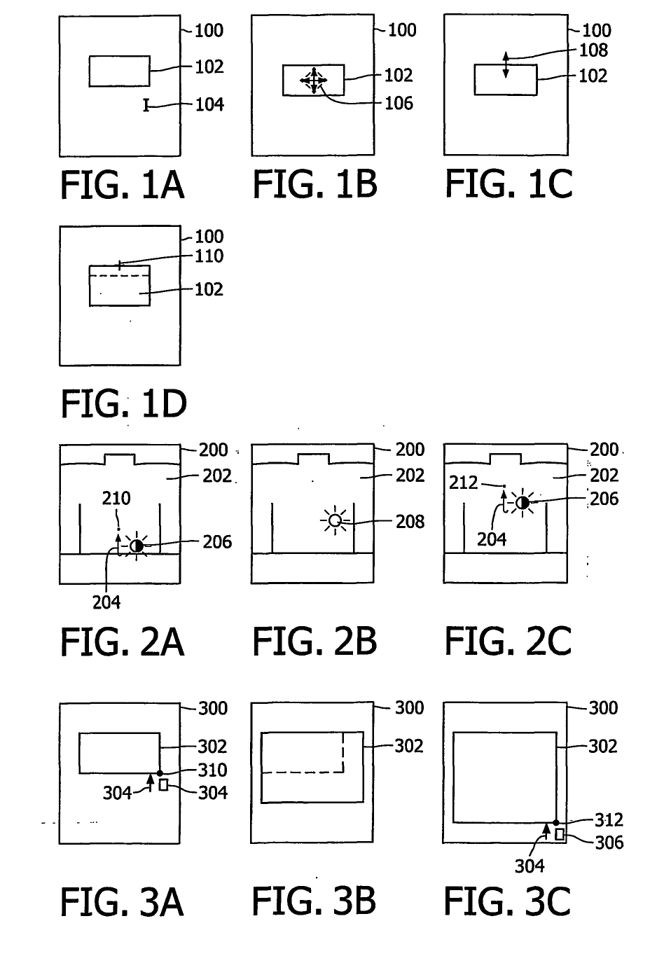

FIG. 1a illustrates an example of a cursor interaction within MsWord. A document 100 comprises an object in the shape of a box 102 and the user is in control of cursor 104. When the user moves cursor 104 inside the box 102, the cursor's representation changes into a cross 106, see FIG. 1b. This cross 106 indicates to a user that the user can select an interaction mode that enables a user to move the box to a different position. When the user selects this “move” interaction mode, and the user moves the box 102 by dragging the cursor to a different position, the cursor keeps its cross shape.

When the user moves the cursor 104 to a corner of the box 102, the cursor's representation changes into a resize-handle 108, see FIG. 1c. This handle indicates to a user that the user can select an interaction mode that enables a user to resize the box 102. When the user selects this “resize” interaction mode, and the user resizes the box 102 by dragging the cursor to a different position, the cursor changes it shape into a small cross 110, see FIG. 1d.

It is an object of the current invention to provide a method according to the opening paragraph that allows a user to interact with an image in an improved way. To achieve this object, the method comprises: moving the pointer to a first position within the image by the user; displaying the pointer corresponding to an interaction mode related to the first position within the image; selecting the interaction mode; moving the pointer to a second position within the image by the user while performing the selected interaction mode upon the image; and hiding the pointer during moving the pointer to the second position within the image. By hiding the pointer during the manipulation of the pointer by a user while performing an interaction with the image, the pointer obscures less of the image. This enables a user to see more of the image during the manipulation. Further it enables a user to see the result of the image manipulation better, because the pointer does not obscure the image.

An embodiment of the method is disclosed in claim 2. An image can comprise a region of interest. For example, in the case of a medical image showing a thorax, the region of interest could be the region of the heart. Then by hiding the pointer within the region of interest during moving the pointer to the second position, the pointer does not obscure a possible pathology within the region of interest.

A further embodiment of the method is disclosed in claim 3. By enabling a user to re-display the hidden pointer the user can dynamically decide to see or hide the cursor during manipulation of the image.

It is an object of the current invention to provide a system according to the opening paragraph that displays a cursor during interaction in an improved way. To achieve this object, the system comprises: a mover for moving the pointer to a first position within the image by the user; a displayer for displaying the pointer corresponding to an interaction mode related to the first position within the image; a selector for selecting the interaction mode; a mover for moving the pointer to a second position within the image by the user while performing the selected interaction mode upon the image; and a hider for hiding the pointer during moving the pointer to the second position within the image.

Embodiments of the system are disclosed within claims 5 and 6.

These and other aspects of the invention will be apparent from and elucidated with reference to the embodiments described hereinafter as illustrated by the following Figures:

FIGS. 1a, 1b, 1c, and 1d illustrate an example of a prior art cursor interaction;

FIGS. 2a, 2b, and 2c illustrate a mouse manipulation within a medical image;

FIGS. 3a, 3b, and 3c illustrate a mouse manipulation within a drawing;

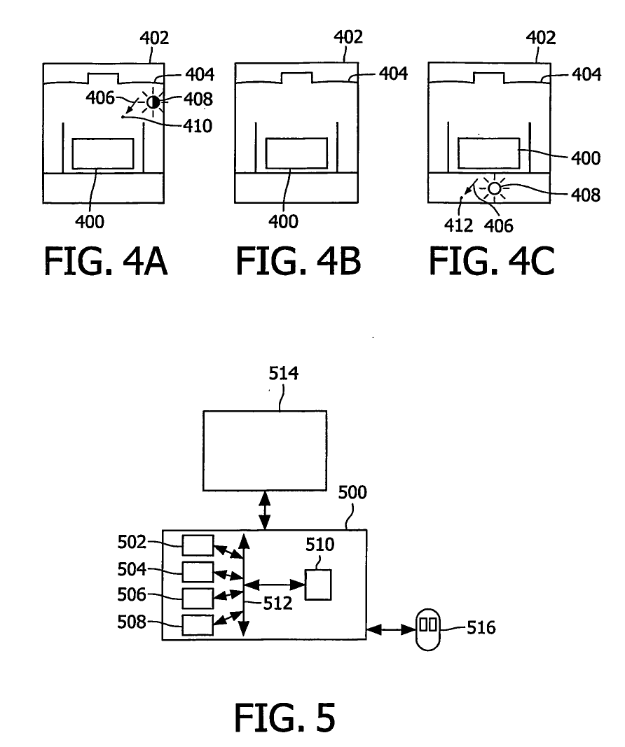

FIGS. 4a, 4b, and 4c illustrate a mouse manipulation within a region of interest;

FIG. 5 illustrates a system according to the invention in a schematic way.

FIG. 2a illustrates a mouse manipulation within a medical image. The medical image 200 is an X-ray image of a thorax 202. In stead of an X-ray image, an other acquisition technique could be used, like Ultrasound, etc. A user is in control of the cursor 204 at position 210, next to the cursor 204 an interaction mode 206 is displayed that indicates that the user can adjust the contrast or brightness of the image 200 by moving the cursor 204. Instead of adjusting the contrast or brightness other image enhancement techniques can be chosen, like changing the window width/window level, re-positioning shutters, change the colour, enhance sharpness, blurring, gamma-correction, etc. The user is in control of the cursor by manipulating a mouse (not shown). The mouse comprises buttons and the user can select the interaction mode by pressing an appropriate button. Other devices of enabling a user to control the mouse and other ways of selecting the interaction mode are also possible. For example, a stylus could be used to control the mouse and a double push of the stylus against a touchsensitive tablet could select the interaction mode. After the user has selected the interaction mode, the cursor changes its representation as illustrated within FIG. 2b. Here, 208 indicates that the user has chosen to adjust the brightness of image 200 while the cursor 204 is hidden. Although the cursor is hidden, the user can still control the position of the cursor by manipulating the input device, i.e. the mouse. After the user has deselected the interaction mode, for example by releasing the appropriate button of the mouse, the cursor is displayed again at the position controlled by the user as illustrated within FIG. 2c. Here, 212 is the new position where the user has navigated the cursor 204 to while adjusting the brightness of the image 200.

FIGS. 3a illustrates a mouse manipulation within a drawing. The drawing 300 comprises a rectangle 302. The drawing 300 can be any kind of drawing like Autocad or a drawing within an editor like MsWord, MsPowerPoint, etc. The rectangle 302 is an shape within the drawing 300. Other shapes are also feasible, like a sphere, polylines, arrows, etc. A user is in control of the cursor 304 at position 310, next to the cursor 304 an interaction mode 306 is displayed that indicates that the user can resize the rectangle 302 by moving the cursor 304. After the user has selected the interaction mode, the cursor is hidden as illustrated within FIG. 3b, while the user is resizing the rectangle 302. The user resizes the rectangle 304 by controlling the position of the hidden cursor by manipulating an input device like the mouse as described above. After the user has deselected the interaction mode, for example by releasing the appropriate button of the mouse, the cursor is displayed again at the position controlled by the user as illustrated within FIG. 3c. Here, 312 is the new position where the user has navigated the cursor 304 to while adjusting the size of the rectangle 304.

FIG. 4a illustrate a mouse manipulation within a region of interest. The region of interest 400 encloses the heart region within a medical image 402 of a thorax 404. A user is in control of the cursor 406 at position 410, next to the cursor 406 an interaction mode 408 is displayed that indicates that the user can adjust the contrast or brightness of the image 402. After the user has selected the interaction mode, the cursor 406 and the interaction mode 408 remain visible until the cursor 406 or the interaction mode 408 enters the region of interest 400. Then, the cursor, 406, the interaction mode 408, or both are hidden so that their representation does not obscure the region of interest 400 as illustrated in FIG. 4b. When the cursor 406 and/or the interaction mode 408 leaves the region of interest, it is shown again as illustrated in FIG. 4c. There the cursor 406 and the interaction mode 408 are displayed at position 412 towards which the user has moved the cursor from its start position as illustrated within FIG. 4a.

In addition to the cursor manipulations as described above, the user is offered to control the display of the cursor. The user can enforce displaying and/or hiding the cursor during, before or after selection of the interaction mode.

FIG. 5 illustrates a system according to the invention in a schematic way. The system 500, comprises a central processing unit (cpu) 510, computer readable memories 502, 504, 506, and 508 that are communicatively connected to each other through software bus 512. The system 500 is further connected to a display screen 514 and an input device 516 like a mouse. The computer readable memory 502 comprises computer readable code that is designed to move a cursor to a first position on the display screen 514 within an image (not shown). A user who manipulates the input device 516 controls the first position of the cursor. The computer readable memory 504 comprises computer readable code that is designed to display the cursor corresponding to an interaction mode related to the first position within the. image as previously described. The computer readable memory 506 comprises computer readable code that is designed to that is designed to select the interaction mode by receiving the corresponding commands from the input device 516. The computer readable memory 504 is further designed to comprise computer readable code for moving the pointer to a second position within the image by the user while the selected interaction mode is being performed upon the image. The computer readable memory 508 comprises computer readable code for hiding the pointer during moving the pointer to the second position within the image as previously described. The computer readable memories are random access memories (RAM), but other memories can be used too like read-only memories (ROM). Further the memories can be integrated into a single memory comprising the whole computer readable code for performing the separate steps of the method according to the invention. The computer readable code can be downloaded into the system 500 from a computer readable medium like a compact disk (CD), a digital versatile disk (DVD) etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, for example an image acquisition device like an MR, X-ray, or Ultrasound scanner, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of visualizing a pointer during interaction of the pointer with an image, the pointer being controllable by a user, the method comprising:
moving the pointer to a first position within the image by the user;
displaying the pointer corresponding to an interaction mode related to the first position within the image;
selecting the interaction mode;
moving the pointer to a second position within the image by the user while performing the selected interaction mode upon the image; and
hiding the pointer during moving the pointer to the second position within the image.

2. Method according to claim 1, wherein the image comprises a region of interest and the step of hiding the pointer comprises hiding the pointer within the region of interest during moving the pointer to the second position.

3. Method according to claim 1, the method further comprising displaying the pointer during moving the pointer to the second position upon request by the user.

4. System (500) for visualizing a pointer during interaction of the pointer with an image, the pointer being controllable by a user, the system comprising:
a mover (502) for moving the pointer to a first position within the image by the user;
a displayer (504) for displaying the pointer corresponding to an interaction mode related to the first position within the image;
a selector (506) for selecting the interaction mode;
a mover (502) for moving the pointer to a second position within the image by the user while performing the selected interaction mode upon the image; and
a hider (508) for hiding the pointer during moving the pointer to the second position within the image.

5. System (500) according to claim 4, wherein the image comprises a region of interest and the hider (508) is arranged to hide the pointer within the region of interest during moving the pointer to the second position.

6. System (500) according to claim 4, wherein the displayer (504) is further arranged to display the pointer during moving the pointer to the second position.

7. Computer program product designed to perform the method according to claim 1.

8. Computer readable medium having stored thereon instructions for causing one or more processing units to perform the method according to claim 1.

9. An imaging diagnostic apparatus for carrying out the method according to claim 1.
